(19) United States
(12) Patent Application Publication
(10) Pub. No.: US 2012/0311624 A1
(43) Pub. Date: Dec. 6, 2012

(54) GENERATING, EDITING, AND SHARING MOVIE QUOTES

(75) Inventors: Ilya Oskolkov, Moscow (RU); Artem Kirakosyan, St. Petersburg (RU); Rodion Shishkov, St. Petersburg (RU); Igor Sokolov, Tver (RU)

(73) Assignee: RAWLLIN INTERNATIONAL INC., Tortola (VI)

(21) Appl. No.: 13/152,869

(22) Filed: Jun. 3, 2011

(51) Int. Cl. H04N 7/16

(52) U.S. Cl. 725/25

(57) ABSTRACT

Described herein are systems, methods, and articles of manufacture that facilitate creation, editing, and sharing of video quotes. A video quote can be created based on user input. For example, the video quote can be created based on a time range selected by a user. The video quote can also include comments from the user. In order to create the video quote, the user can be authenticated and/or permissions of the user related to viewing, editing and/or sharing of the video can be verified. If permissions are verified, the user can edit the content of the video quote, for example, by changing the time range and/or including different comments. The video quote can be shared, for example, on a social network and/or via e-mail.

### TECHNICAL FIELD

This disclosure relates generally to facilitation of generating, editing, and sharing of video quotes.

### BACKGROUND

“Video quotes” or video clips are short clips of video often created on a personal computer. Video quotes are often clips of a longer recording, such as a movie, music video, home movie, or the like. For example, a user who likes the movie Casablanca can create a movie quote of a famous scene where Humphrey Bogart tells Ingrid Bergman, “Here's looking at you, kid.” The clip can be several seconds long or several minutes. Due to the prevalence of broadband Internet connections, video quotes have become popular online. Some online sites, for example, host millions of user-created video quotes. The user can share a video quote with friends, for example, by providing a link to the video quote on the site to friends on a social networking site.

Recently, video playback devices (e.g., mobile devices) have become equipped with broadband internet capabilities and computer processing power that enable the mobile device users to record and display video. However, due to limitations, creation and sharing of video quotes on a mobile device has been difficult. For example, limitations can include small screens, limited storage capabilities, lack of a full keyboard, or lack of network speed, and the like.

The above-described deficiencies of conventional video quote generation, editing and sharing environments and practices are merely intended to provide an overview of some of problems of current technology, and are not intended to be exhaustive. Other problems with the state of the art, and corresponding benefits of some of the various non-limiting embodiments described herein, may become further apparent upon review of the following detailed description.

### SUMMARY

The following description and the annexed drawings set forth in detail certain illustrative aspects of the disclosed subject matter. These aspects are indicative, however, of but a few of the various ways in which the principles of the various embodiments may be employed. The disclosed subject matter is intended to include all such aspects and their equivalents. Other advantages and distinctive features of the disclosed subject matter will become apparent from the following detailed description of the various embodiments when considered in conjunction with the drawings.

Described herein are systems, methods and articles of manufacture that facilitate generating, editing, and sharing of video quotes. The systems, methods and articles of manufacture described herein can be implemented in connection with any type of device capable of video playback. According to a non-limiting embodiment, the device can be a mobile device, such as a mobile handset, operating in a wireless communication network. According to further non-limiting embodiments, the device can be a television, a computer a handheld device, a video gaming device, a media player, or the like. It will be understood that “device” or “video playback device” or “mobile device” as utilized herein can relate to any device capable of video playback.

According to an embodiment, described is a method for generating a video quote. The method can begin upon receiving a request from a video playback device for content related to a video. The request can include a time range for the content related to the video. The request can also include a tag related to the video, such as a unique identification (UID) number, which can identify, for example, a chapter of the video. The request can, additionally or alternatively, include one or more comments about the video quote. After the request is received, a user of the video playback device can be validated and/or authenticated to view, edit and/or share the content related to the video. The method can also include sending a link to the content related to the video formatted in accordance with the time range, the UID, and/or the comment (a “video quote”) to the video playback device. According to a non-limiting example, the video quote can be shared, for example, by e-mail and/or by uploading to a social network (e.g., through posting a link on a wall). According to a further non-limiting example, the video quote can be downloaded to a local folder on the device. According to another non-limiting example, the video quote and/or a link to the video quote can be posted to a social network wall, online forum, online blog, or the like.

In accordance with another embodiment, described is a system that can generate a video quote. The system can include a receiving component configured to receive a request for content related to a video from a video playback device. As described above, the request can include a time range for the content, a UID related to the content, and/or a comment related to the content. The system can also include a security component configured to validate permissions related to the request. For example, the security component can be configured to authorize a user of the video playback device to view, edit and/or share parts of the video. The system can also include a context component configured to create a video quote that includes the content related to the request in accordance with the time range, UID and/or comment. The system can also include a response component configured to send a link to the video quote to the video playback device. The system can also include a publishing component that can facilitate sharing the video quote via e-mail and/or a social network.

In yet another embodiment, described herein is an article of manufacture (a computer readable storage medium) having stored thereon computer executable instructions that, in response to execution, cause a computing system to perform operations. The operations can include authorizing a user of a video playback device to edit a video. The operations can also include creating a clip of the video based, for example, on a UID associated with the video and a time range for the clip. The operations can further include associating the clip with a comment from the user of the video playback device. The operations can also include sending a link to the clip and the comment to the video playback device. The operations can also include publishing the clip to a social network and/or e-mailing the clip.

According to another embodiment, described herein is a method for creating, editing, and/or sharing a video quote. The method begins with displaying a video on a screen of a video playback device and pausing the video upon a command from a user. After the video is paused, the method continues with displaying snapshots (stills) of the video at different times across a predetermined time interval (e.g., from 25 seconds before the pause to 5 seconds after the pause). The method continues with creating the video quote by editing the time interval to include snapshots indicated by a user to be included in the video quote. The method can further include adding a title and/or comments to the video quote. The method can also include publishing the video quote to a social network and/or sharing the video quote via e-mail.

In accordance with a further embodiment, described herein is a system that creates, edits, and/or shares a video quote. The system can include a player component configured to display a video on a video playback device. The system can also include a clip component configured to pause the video and create a clip of the video. The system can also include an editing component configured to adjust the length of the clip, for example, according to a user input. The system can also include a comment component configured to add a comment and/or a title to the clip and create a video quote. The system can also include a publishing component that facilitates sharing the video quote via e-mail or uploading the clip to a social network (e.g., through posting a link on a wall). According to a further non-limiting example, the video quote can be downloaded to a local folder on the device. According to another non-limiting example, the video quote and/or a link to the video quote can be posted to a social network wall, online forum, online blog, or the like.

According to yet another embodiment, described herein is an article of manufacture (a video playback device, such as, a mobile device, a television, a computer, a handheld device, a video gaming device, a media player, or the like) that can create, edit and/or share a video quote. The video playback device can include certain means, including a means for playing a film, means for pausing the film, means for creating a clip of the film when the film is paused, and means for publishing the clip of the film, for example, via e-mail or a social network.

These and other embodiments are described in more detail below with reference to the drawings.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates a block diagram of a system that creates a video quote according to an embodiment.

FIG. 2 illustrates a block diagram of a system for that creates and shares a video quote according to an embodiment.

FIG. 3 illustrates a block diagram of a system that creates, shares and saves a video quote according to an embodiment.

FIG. 4 illustrates a block diagram of a system that creates and shares a video quote according to an embodiment.

FIG. 5 illustrates a process flow diagram of a method for creating a video quote according to an embodiment.

FIG. 6 illustrates a process flow diagram of a method for authenticating a user to edit a video and creating a video quote according to an embodiment.

FIG. 7 illustrates a process flow diagram of a method for creating and sharing a video quote according to an embodiment.

FIG. 8 illustrates a block diagram of a system that creates and edits a video quote according to an embodiment.

FIG. 9 illustrates a block diagram of a system that creates, edits and shares a video quote according to an embodiment.

FIG. 10 illustrates a block diagram of a system that creates, edits and previews a video quote according to an embodiment.

FIG. 11 illustrates an example schematic diagram of a video playback device display when the video playback device is executing a system for creating and editing a video quote according to an embodiment.

FIG. 12 illustrates an example schematic diagram of a video playback device display when the video playback device is executing a system for creating, editing and sharing a video quote according to an embodiment.

FIG. 13 illustrates a process flow diagram of a method for creating and editing a video quote according to an embodiment.

FIG. 14 illustrates a process flow diagram of a method for creating and editing a video quote according to an embodiment.

FIG. 15 illustrates a process flow diagram of a method for creating and editing a video quote.

FIG. 16 illustrates a process flow diagram of a method for creating and sharing a video quote according to an embodiment.

FIG. 17 illustrates a block diagram of a system that searches a database of videos and returns a video clip containing a video quote.

FIG. 18 illustrates a process flow diagram of a method for receiving a video clip based on a video quote.

FIG. 19 illustrates a process flow diagram of a method for finding a video clip based on a video quote.

FIG. 20 illustrates an example schematic diagram of a mobile device (e.g., a mobile handset) that can generate, edit and share video quotes in accordance with the embodiments described herein.

FIG. 21 illustrates a block diagram of a computer operable to execute a system architecture that facilitates generating, editing, and sharing of video quotes according to the embodiments described herein.

### DETAILED DESCRIPTION

In the following description, numerous specific details are set forth to provide a thorough understanding of various embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The words “exemplary” and/or “demonstrative” are used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

As an overview of the various embodiments presented herein, to correct for the above identified deficiencies of video playback devices with regard to generating, editing and publishing video quotes and other drawbacks of generating, editing and publishing video quotes in general, various systems, methods and articles of manufacture described herein enable users of a video playback device to generate, edit and/or share video quotes. As described herein, a “video quote,” “movie quote,” “film quote,” “video clip,” “movie clip,” and the like, are all intended to describe a portion of a movie and/or video extracted from a full-length movie and/or video and/or home movie and/or music video, or the like. In this regard, in various embodiments, users of devices (e.g., video playback devices, such as a mobile device, a television, a computer, a handheld device, a video gaming system, a media player, or the like) are provided with the ability to create and edit video quotes on their device. Additionally, device users are able to share a video quote with friends, for example, on a social networking site and/or via e-mail. Additionally, the terms “movie,” “video,” and/or “film” are intended to encompass all types of digital video. As used herein, the term “user” is intended to reflect the originator of the quote and need not be human. For example, a “user” can be an autonomous machine.

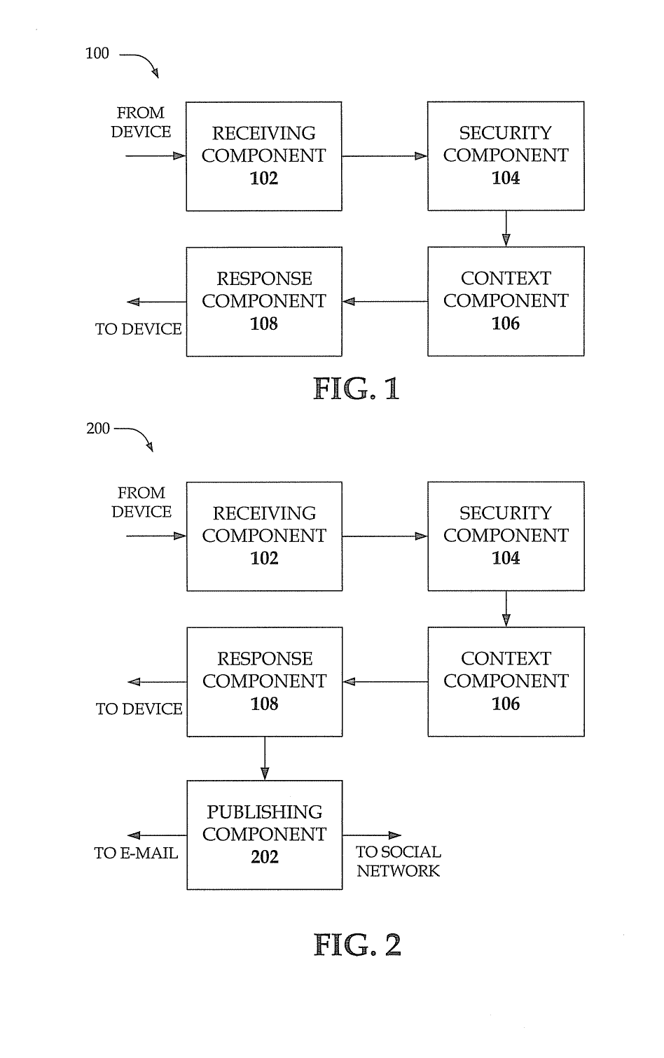

Referring now to FIG. 1, illustrated is a schematic block diagram of a system 100 that creates a video quote according to an embodiment. Aspects of system 100, and systems, networks, other apparatus, and methods described herein can constitute machine-executable instructions embodied within machine(s), e.g., embodied in one or more computer readable mediums (or media) associated with one or more machines. Such instructions, when executed by the one or more machines, e.g., computer(s), computing device(s), virtual machine(s), etc. can cause the machine(s) to perform the operations described.

Additionally, the systems and methods described herein can be embodied within hardware, such as an application specific integrated circuit (ASIC) or the like. Further, the order in which some or all of the process blocks appear in each process should not be deemed limiting. Rather, it should be understood by a person of ordinary skill in the art that some of the system components and/or process blocks can be executed in a variety of orders not illustrated.

System 100 can create a video quote based on a received request for content related to a video. Accordingly, system 100 can include a receiving component 102 that can be configured to receive a request for content related to a video. The request can, for example, be received from a video playback device (not shown), such as a mobile handset. According to an aspect, the request can specify features of the content. For example, the request can identify the video (e.g., through a unique identification number (UID) identifying a specific chapter within a video). The request can also, for example, include a time range for the content. Further the request can also include, for example, one or more comments related to the content. The comments can include general comments related to the video as a whole and/or specific comments related to the content related to the video (e.g., a video clip). For example, the comments can be user-defined and include an opinion. As a practical, non-limiting, example, using the Casablanca example described above, the request can include a UID identifying Casablanca as the movie, a time range identifying the famous scene where Humphrey Bogart tells Ingrid Bergman, “Here's looking at you, kid” (e.g., the time range can be several seconds or several minutes), and a comment from the user indicating, for example, “This is the best scene ever.” It should be understood that the video need not be a commercially-released movie. The video can be any video content. According to a non-limiting example, the video can be a home movie filmed by a camera on the device and the content related to the movie can be a funny moment within the home movie.

System 100 can further include a security component 104 that can be configured to validate permissions related to the content. For example, the security component 104 can determine whether a user of the video playback device that initiated the request has permissions to view and/or edit the video. For example, the video can be associated with digital rights management protections that prohibit a user from editing the video. If the user does not have rights to view and/or edit the video, the security component 104 can prevent the user from making the video quote. For example, security component 104 can produce an error message indicating that the user does not have permission to edit the video.

The security component 104 can, additionally or alternatively, authenticate the user by validating an identity of the user (e.g., through a stored username and associated password). After authenticating the user, the security component 104 can examine permissions associated with the user in connection with the video. If the security component 104 determines that the user has permissions allowing the user to view and/or edit the video, the security component 104 can issue a session token for the user based on the permissions.

After the security component 104 ascertains that the user is permitted to edit the video, a context component 106 creates the video quote. The video quote can, for example, include a clip of the video identified by the UID for the specified time range (e.g., the scene from Casablanca described above). The video quote can also include comments from the request (e.g., “This is the best scene ever,” as described above). The context component 106 can create the video quote, for example, in a flash video format. System 100 can also include a response component 108 that can send a link to the video quote to the video playback device, which can, for example, enable the user to preview the video quote.

For example, system 100 can enable a user to create a video quote. As a practical, non-limiting, example, a user can be running a video context (e.g., Yota Video) on his mobile phone. The user can be logged into a context server associated with the video context. Upon successful login, security component 104 can validate permissions associated with the user and issue a session token to the user, allowing the user to view and edit content related to a video. The video can have a copy in flash video format, which can allow for the video clip to be created with comparatively bad quality to the original video.

The user can open a player on his device (e.g., a mobile phone, a television, a computer, a handheld device, a video game player, a media player, or the like) and view a video (e.g., Casablanca). While viewing the video, the user can select content of the video (e.g., a specific scene like, “Here's looking at you, kid.”) bounded by a specific time frame (e.g., several seconds or minutes). The user can also write comments associated with the content (e.g., “This is the best scene ever.”). A client associated with the video playback device can send a request, including reference to the video and the specific scene bounded by a time frame, as well as the comments, to the receiving component 102.

A context server associated with system 100 can employ the receiving component 102, the security component 104, the context component 106, and the response component 108. The receiving component 102 can receive the request, and the security component 104 can validate the request. Upon validation, the request can be sent to the context component 106. The context component 106 can generate the video quote, including the scene defined over the time range, in flash video format. The context component 106 can also associate the comments with the scene in the video quote. After the video quote is created, the response component 108 can send a link to the video quote on the context server to the video playback device. For example, the user of the video playback device can utilize the link to preview the video quote. The user of the video playback device can also utilize the link to download and save the video quote.

Upon creation of the video quote, if permissions allow, the user of the video playback device can share the video quote. Referring now to FIG. 2, illustrated is a block diagram of a system 200 that facilitates sharing of a video quote. System 200 can include the components of system 100 as described above (e.g., a receiving component 102, a security component 104, a context component 106, and a response component 108) to create the video quote. As described above, the video quote can include a short clip including content of a video referenced by a UID and defined over a period of time. The video quote can also include comments from a user regarding the clip and/or the video. The response component 108 can send a link to the video quote so that the video quote can be previewed and approved by the user.

After the video quote is created, if the user has appropriate permissions to share content of the video, the video quote can be shared. Accordingly, system 200 can include a publishing component 202 that can facilitate sharing the video quote. For example, the publishing component 202 can share the video quote by e-mailing the video quote. The user can enter an e-mail address of a person the user wants to share the video quote with and publishing component 202 can compose and/or send an email to the e-mail address specified by the user including the link to the video quote and/or an attachment of the video quote. According to another example, publishing component 202 can present a list of stored e-mail addresses to the user, and receive a selection of one or more e-mail addresses that the user wants to share the video quote with. Publishing component 202 can compose and/or send an email to the selected on or more e-mail addresses that includes a link to the video quote and/or an attachment of the video quote. After logging into the social network, but publishing component 202 can publish the video quote (including the video scene, wherein the video is identified by the UID and the scene is defined by the time interval, and the associated comment) to the social networking site.

Publishing component 202 can also share the video quote by publishing the video quote to a social networking site. For example, if the user has stored credentials (e.g., a username and an associated password) to a social networking site (e.g., a linked social network), the publishing component 202 can access the stored credentials for the social networking site. The publishing component 202 can automatically log into the social networking site with the stored credentials.

For example, system 200 can enable a user to share a video quote. As a practical, non-limiting, example, a user can have a login and password for a social networking site stored within a context server. The context server can include publishing component 202. If the user has a saved username and password to a social network (e.g., saved within Yota Video), the publishing component 202 can upload the video quote to the social network, where friends of the user on the social network can view the video quote including the scene and the associated comments. The term “upload” can include, but is not limited to posting the video quote and/or a link to the video quote to a social network wall, online forum, online blog, or the like.

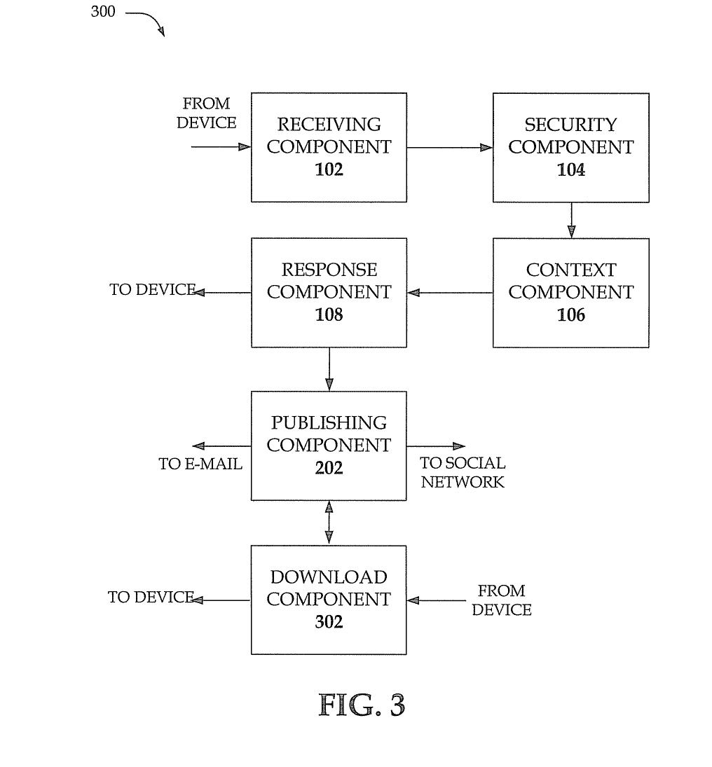

If the user does not have saved credentials for a social networking site, a user is still able to share the video quote over a social network. Referring now to FIG. 3, illustrated is a block diagram of a system 300 that facilitates sharing the video quote if a user does not have a stored username and password for a social networking site. System 300 can include the components of system 100 as described above (e.g., a receiving component 102, a security component 104, a context component 106, and a response component 108) to create the video quote. System 300 can also include a publishing component 202 with functionality as defined with reference to system 200.

Publishing component 202 can search for saved credentials to a social network site. Upon not finding the saved login and password, the publishing component 202 determines if the user is engaged in a valid Web session. If the user is engaged in a valid Web session, the publishing component can trigger a download component 302 to download the video quote to the video playback device. After the video quote is downloaded to the video playback device, the user can login to a social networking site and upload the video quote to the social networking site. The term “upload” can include, but is not limited to posting the video quote and/or a link to the video quote to a social network wall, online forum, online blog, or the like. Additionally or alternatively, the download component 302 can receive credentials (e.g., a username and password) to log in to the social networking site. The publishing component 202 can use the credentials to log into the social networking site and upload the video quote to the social networking site.

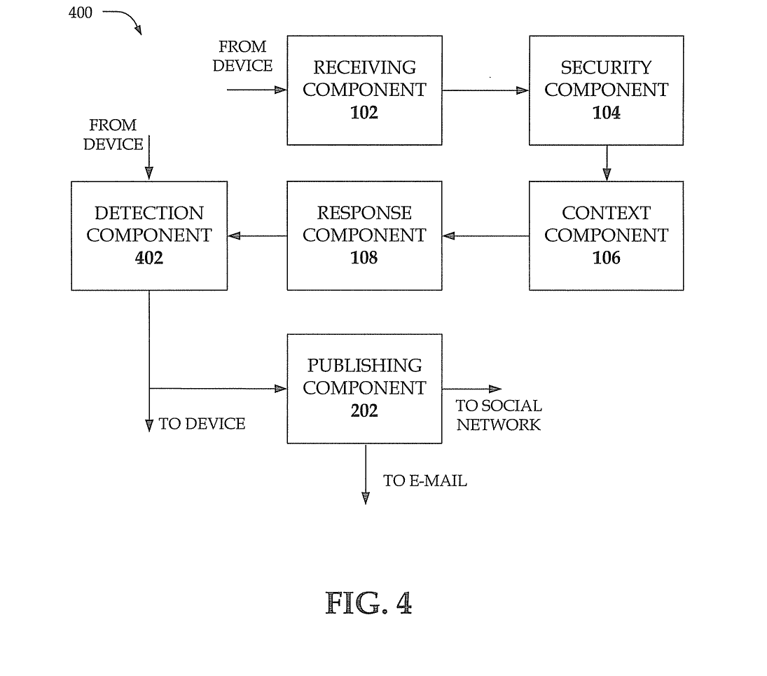

If the user is not running a valid Web session, so that a download is impossible (e.g., a browser client), a user is still able to share the video quote over a social network. Referring now to FIG. 4, illustrated is a block diagram of a system 400 that facilitates sharing the video quote if a user is not running a valid Web session. System 400 can include the components of system 100 as described above (e.g., a receiving component 102, a security component 104, a context component 106, and a response component 108) to create the video quote. System 400 can also include a publishing component 202 with functionality as defined with reference to system 200.

Publishing component 202 can search for saved credentials to a social network site. Upon not finding the saved login and password, the publishing component 202 can engage detection component 402 to determine if the user is engaged in a valid Web session. If the user is not engaged in a valid Web session, the detection component 402 can identify a browser client on the video playback device. If the detection component 402 detects that the user is not engaged in a valid web session, the publishing component 202 can facilitate a manual download of the video quote to the video playback device. The publishing component 202 can also facilitate a manual upload of the video quote to a social networking site.

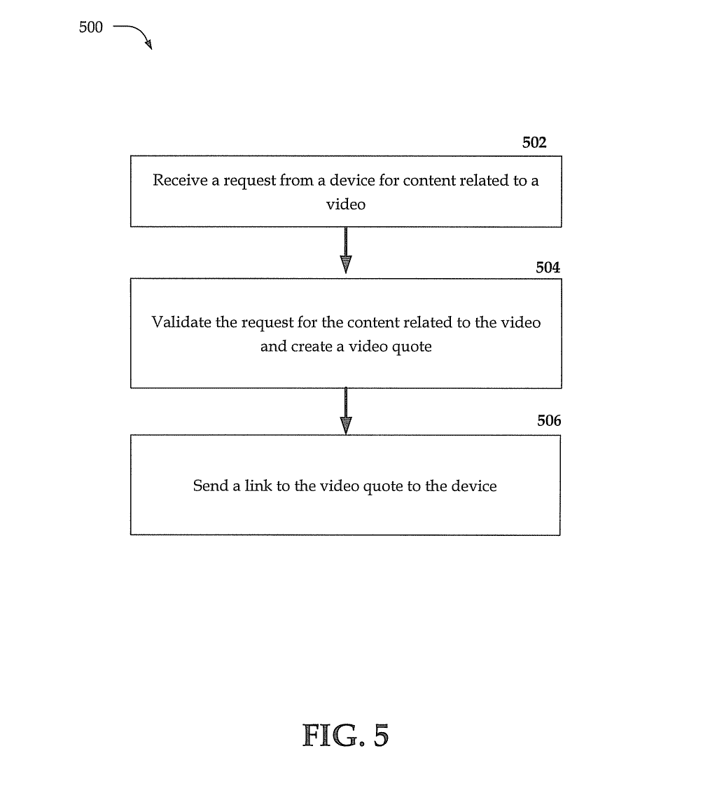

FIGS. 5-7 illustrate methods for generating, editing and/or sharing a video quote. For simplicity of explanation, the methodologies are depicted and described as a series of acts. It is to be understood and appreciated that the various embodiments are not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methods described hereafter are capable of being stored on an article of manufacture (e.g., a computer readable storage medium) to facilitate transporting and transferring such methodologies to computers. The term article of manufacture, as used herein, is intended to encompass a computer program accessible from any computer-readable device, carrier, or media.

Referring now to FIG. 5, illustrated is a process flow diagram of a method 500 for creating a video quote. At element 502, a request for content related to a video can be received from a video playback device. For example, the video playback device can be running a video context program. The request can be received by a context server that stores a copy of the video, for example, in a flash media format. A user of the video playback device can be authorized in the context server to view, edit and/or share the video. After the user is successfully logged in to the context server and associated with appropriate permissions to view, edit and/or share the video, the user can be associated with a session token so that the user can view, edit and/or share the video.

The request can include a video UID identifying the video and/or a chapter within the video. The request can also include a time range defining the content related to the video. For example, the time range can define a scene in a video that will be used as a clip. The request can also include one or more comments related to the video and/or the scene.

At element 504, the request is validated, for example, according to the session token, and a video quote can be created including the clip, defined according to the video UID and the time range, and the one or more comments. The video quote can be created in a flash video format. The video quote in the flash video format has a lower quality than the original video.

At element 506, a link to the video quote can be generated and sent to the video playback device. The link can be, for example, to the video quote stored, for example, on the context server. A user can utilize the link to preview the video quote. The user can also utilize the link to facilitate downloading the video quote.

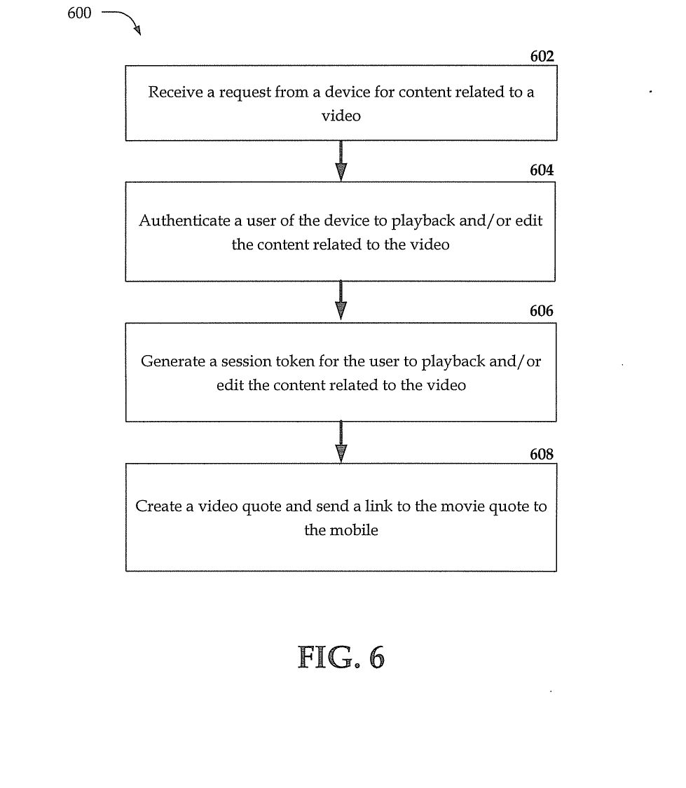

Referring now to FIG. 6, illustrated is a process flow diagram of a method for generating a video quote. At element 602, a request for content related to a video can be received from a video playback device. For example, the video playback device can be running a video context program. The request can be received by a context server that stores a copy of the video, for example, in a flash media format.

At element 604, a user of the video playback device can be authorized in the context server to playback, edit and/or share the video and/or content related to the video. The content server can examine permissions associated with the user and/or the video and authorize the user according to the permissions to view, edit and/or share the video. After the user is authorized, at element 606, a session token can be generated so that the user can view, edit and/or share the video.

At element 606, a link to the video quote can be generated and sent to the video playback device. The link can be, for example, to the video quote stored, for example, on the context server. A user can utilize the link to preview the video quote. The user can also utilize the link to facilitate downloading the video quote.

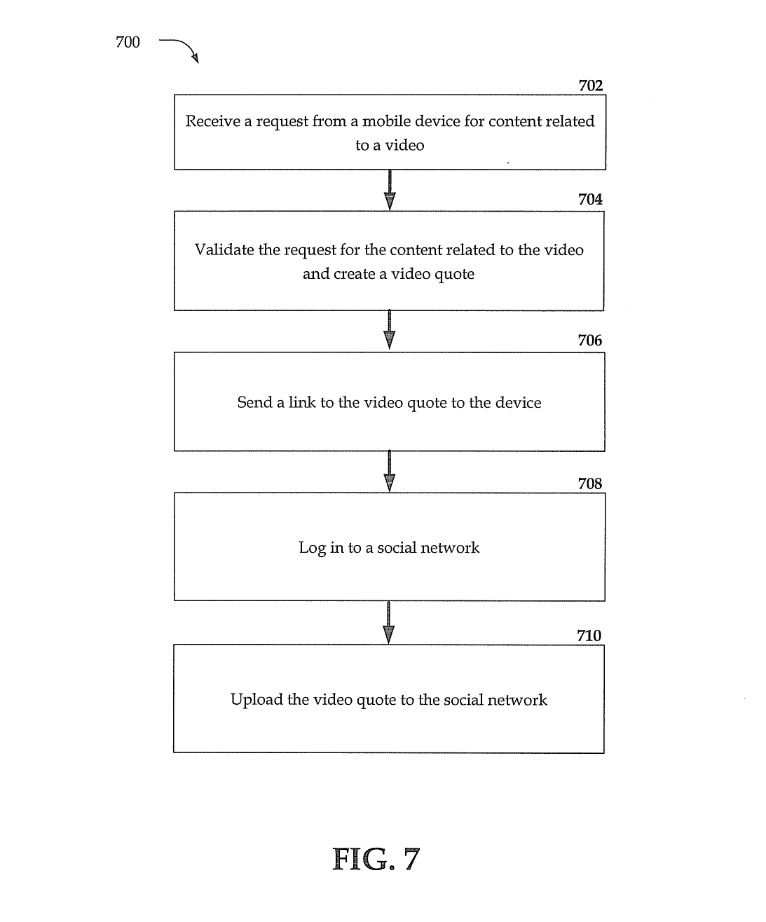

Referring now to FIG. 7, illustrated is a process flow diagram of a method for generating and sharing a video quote. At element 702, a request can be received from a video playback device for content related to a video. The request can be received by a context server that stores a copy of the video, for example, in a flash media format. A user of the video playback device can be authorized in the context server to view, edit and/or share the video. After the user is successfully logged in to the context server and associated with appropriate permissions to view, edit and/or share the video, the user can be associated with a session token so that the user can view, edit and/or share the video.

The request can include a video UID identifying the video and/or a chapter within the video. The request can also include a time range defining the content related to the video. For example, the time range can define a scene in a video that will be used as a clip. The request can also include one or more comments related to the video and/or the scene.

At element 704, the request is validated, for example, according to the session token, and a video quote can be created including the clip, defined according to the video UID and the time range, and the one or more comments. The video quote can be created in a flash video format. The video quote in the flash video format has a lower quality than the original video.

At element 706, a link to the video quote can be generated and sent to the video playback device. The link can be, for example, to the video quote stored, for example, on the context server. A user can utilize the link to preview the video quote. The user can also utilize the link to facilitate downloading the video quote.

At element 708, a user can log in to a social network and at element 710, the video quote can be published to the social network. For example, the user can have credentials (e.g., a user name and a password) for the social networking site stored on the context server. In this case, the context server can utilize the credentials and automatically log into the social networking site. If the user does not have credentials for the social networking site stored on the context server, if the video playback device has a valid Web session, the video client associated with the video playback device can download the video quote to the video playback device, requests that the user input credentials to a social networking site, and the video quote can be uploaded to the social networking site. If the video playback device does not have a valid Web session, a user can manually publish the video quote. The terms “upload” and/or “publish” can include, but are not limited to posting the video quote and/or a link to the video quote to a social network wall, online forum, online blog, or the like.

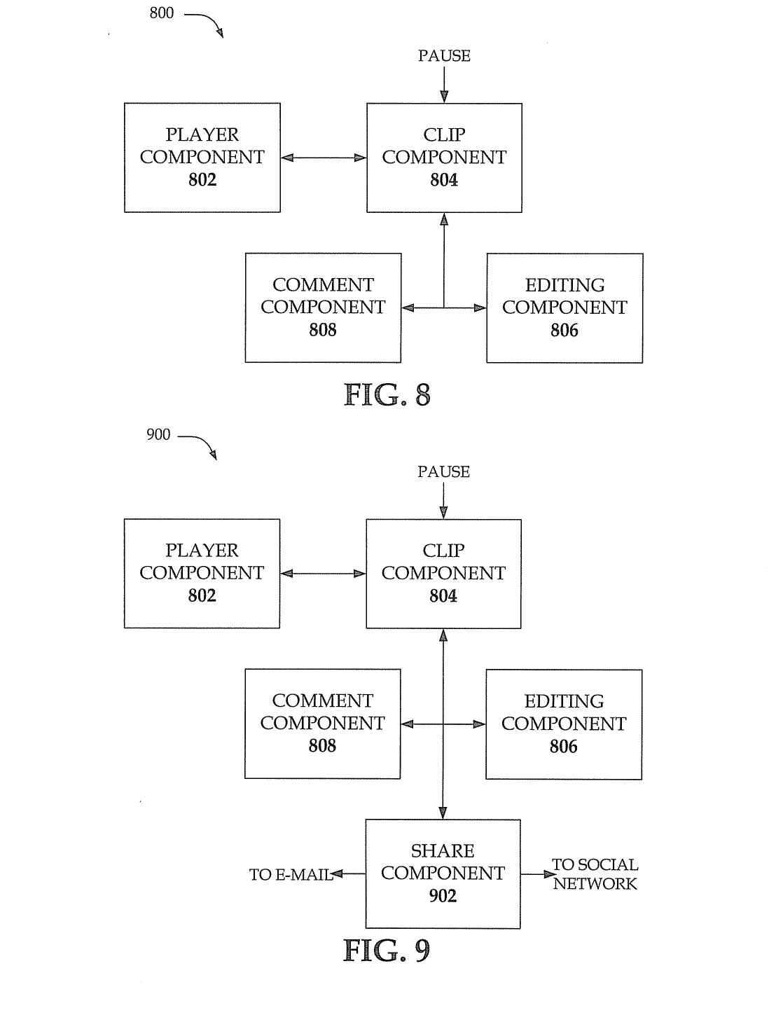

A user can create a video quote while watching a video on a video playback device. Referring now to FIG. 8, illustrated is a block diagram of a system 800 that can create and edit a video quote while a user is watching a video on a video playback device (not shown). System 800 can, for example, be executed on a video playback device, such as a mobile handset. For example, system 800 can be embodied within a video context (e.g., Yota Video) as described above.

System 800 can include a player component 802 that can display the video on the video playback device. For example, using the non-limiting example above, the player component can display the video Casablanca so that the user can watch Casablanca on his video playback device. The player component 802 can include buttons common to a video playback application including, but not limited to: play, stop, pause, fast forward and rewind.

The system 800 can also include a clip component 804, which can pause the video and create a clip of the video. The clip component 804 can receive an indication to pause the video. For example, a user can press a “pause” button, and the clip component 804 can receive an input from pressing the pause button, which can indicate to the clip component 804 that a clip should be created. While a pause button is described herein, it should be understood that the pause button is merely exemplary and not intended to be limiting. Any input signal can be utilized to trigger the clip component 804 to create a clip.

Upon receiving the signal to create the clip, the video can be paused in the player component 802. The clip component 804 can create snapshots (e.g., still images) of the video over a certain time period and display the snapshots (e.g., in a horizontal line across the bottom of the player component 802 while hiding the buttons of the player component 802). The clip component 804 can generate the snapshots for a time interval. For example, the clip component 804 can generate the snapshots for a time period between approximately twenty-five seconds before the signal is received (e.g., the pause button is pressed) and approximately five seconds after the signal is received. Although a thirty second time interval is described herein, it will be understood that the time interval can be shorter or longer than thirty seconds. The clip component 804 can generate the snapshots at an equal spacing over the time interval. For example, for the thirty second time interval, the clip component 804 can generate seven snapshots each spaced five seconds apart. According to another non-limiting example, the clip component 804 can generate three snapshots each spaced fifteen seconds apart across the thirty second time interval.

Referring to the Casablanca example above, a user can pause Casablanca at a point during the “Here's looking at you, kid” scene. The clip component 804 can hide the controls of the player component 802 and display seven snapshots (e.g., video capture images) across the bottom of the player component 802. The still images can be taken every five seconds from twenty five seconds before the pause button is pressed until five seconds after the pause button is pressed.

Upon generation of the snapshots, an editing component 806 can define and/or adjust a length of a clip of the video that will be created. For example, the editing component 806 can receive an input from the user and adjust the length of the clip accordingly. For example, the editing component 806 can provide two handles within the snapshots displayed at the bottom of the player component 802. A user can adjust a location of one or both of the handles to define the length of the video clip. For example, according to the Casablanca example as described above, the editing component 806 can provide adjustable handles located around the middle two snapshots. A user can move the handles, for example, to include one further snapshot to the left and two further snapshots to the right. Accordingly, the clip can include five snapshots and be twenty seconds long.

After the length of the video clip is indicated, a comment and/or a title can be associated with the video quote. The video quote can include the video clip, the comment and/or the title. Accordingly, system 800 can include a comment component 808 that can receive a comment from the user. The comment can, for example, be regarding the video, such as “I love Casablanca,” or regarding the scene in the clip, such as “This is the best scene ever!”

The comment component 808 can also receive a title for the video quote. The title can be user defined. For example, “Here's Looking at You Scene,” or the like. If no title is received, the comment component 808 can create a default and/or random title. For example, “C541S,” or the like.

According to a non-limiting example, system 800 can send information about the video (e.g., a video UID or other information that can identify the video), the time range selected through the editing component 806, any comments and/or the title to a context server as described above. The context server can create the video quote according to the specifications from system 800. System 800 can also include a component (not shown) that can facilitate downloading the video quote to storage associated with the video playback device.

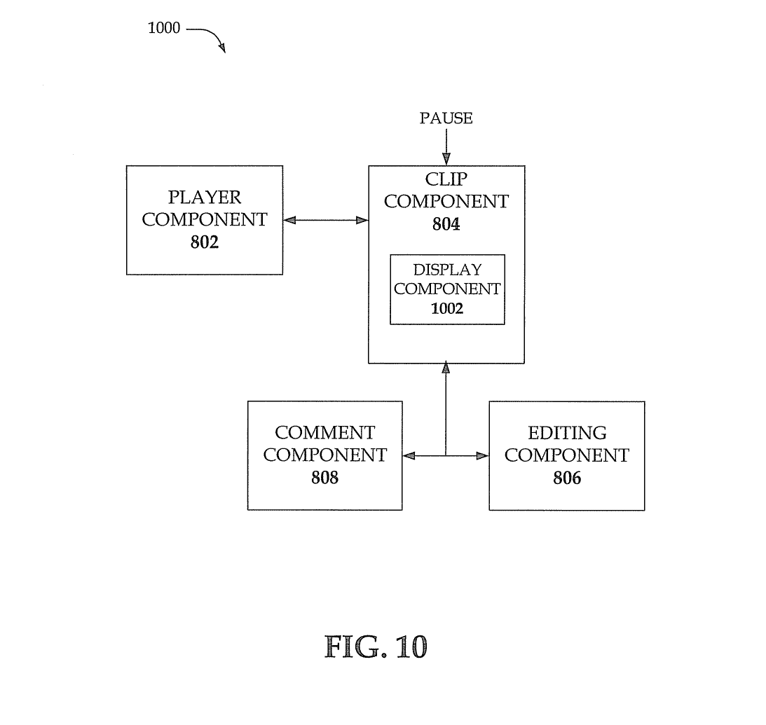

After the context server creates the video quote, the video quote can be shared, for example, by e-mail or to a social network. Referring now to FIG. 9, illustrated is a block diagram of a system 900 that can facilitate creating, editing and sharing a video quote. System 900 can include the components of system 800 as described above (e.g., a player component 802, a clip component 804, an editing component 806, and a comment component 808) to facilitate creation and editing of the video quote. Upon creation of the video quote, system 900 can facilitate sharing the video quote via share component 902.

Share component 902 can facilitate sharing the video quote, for example, by e-mail. A user can provide e-mail addresses of recipients of the video quote. For example, the user can select from potential recipients that can be stored in a memory associated with system 900. According to another example, the user can enter recipients into a field within the share component 902. Additionally or alternatively, share component 902 can facilitate sharing the video quote, for example, by uploading and/or publishing the video quote to a social network.

According to a non-limiting example, system 900 can send information regarding e-mail addresses that will receive the video quote and/or a social network to the context server. Upon creation of the video quote, the context server can e-mail the video quote to recipients specified by the share component 902. Additionally or alternatively, the context server can publish the video quote to a social network according to information received from the share component 902.

After the context server creates the video quote, the video quote can be previewed, for example, by a user of the video playback device. Referring now to FIG. 10, illustrated is a block diagram of a system 1000 that can facilitate creating, editing and previewing a video quote. System 1000 can include the components of system 800 as described above (e.g., a player component 802, a clip component 804, an editing component 806, and a comment component 808) to facilitate creation and editing of the video quote. Upon creation of the video quote, system 1000 can allow a user to preview the video quote.

System 1000 can include a display component 1002. The display component 802 can be embodied within the clip component 804 as illustrated, or within the player component 1002 (not shown). The display component 1002 can allow a user to preview the video quote before it is shared. If the user approves of the video quote, the display component 1002 can send an indication to the context server that the video quote can be shared. If the user does not approve of the video quote, the display component 1002 can send an indication to the context server that the video quote is cancelled. The display component 1002 can send an indication to the player component 802, the clip component 804, the editing component 806 and/or the comment component 808 that the user has rejected the video quote. The user can create and/or edit a revised video quote as described above. According to another example, system 1000 can include an editing component (not illustrated) that can facilitate editing the video quote.

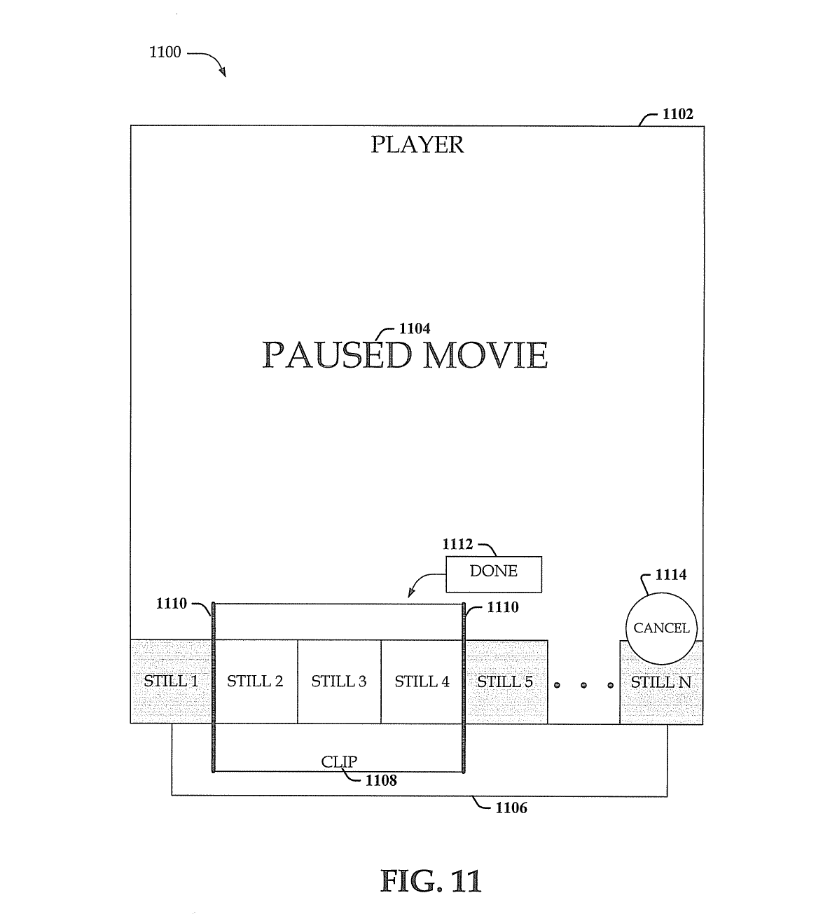

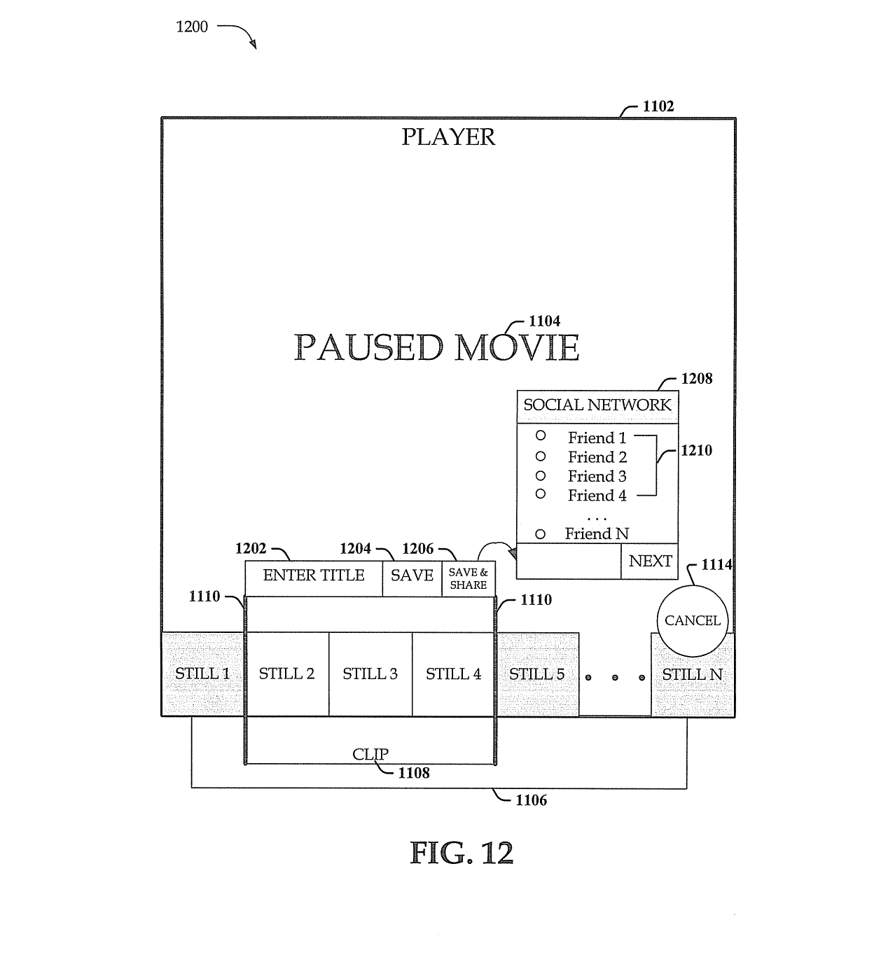

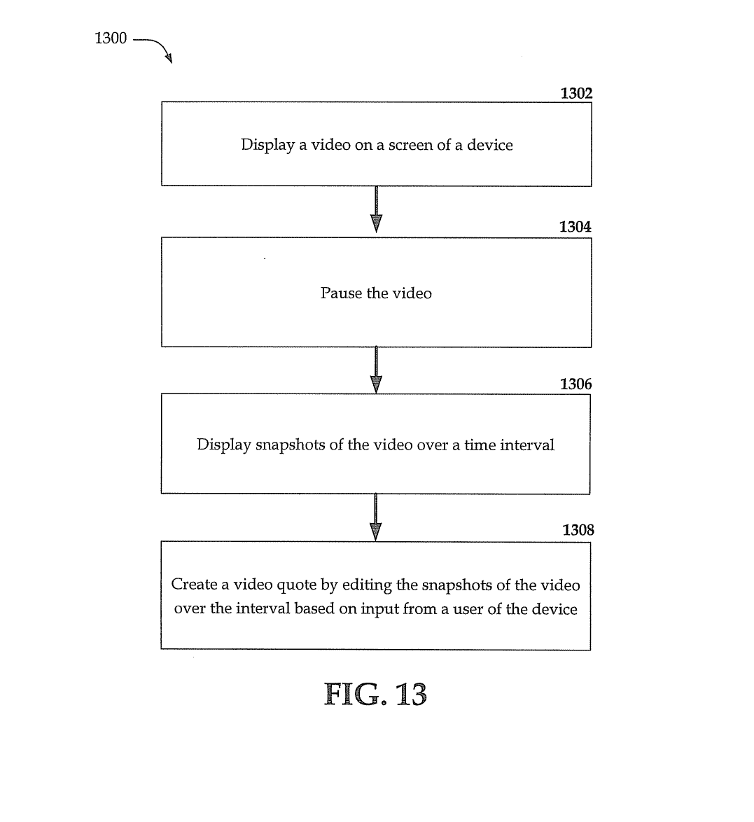

Referring now to FIGS. 12 and 13, illustrated are schematic examples of systems 800-1000. The schematic examples illustrate systems 800-1000 displayed on a video playback device. For simplicity of explanation, the examples will be described with reference to how the systems 800-1000 would look when displayed on a video playback device. It should be understood that FIGS. 11 and 12 provide concrete examples of the systems 800-1000 described herein. It will be understood that the systems 800-1000 can be displayed in different manners than those illustrated in FIGS. 11 and 12 and that these manners of display (e.g., with greater or fewer buttons, different manners of display, or the like) are intended to be within the scope of the disclosure.

Referring now to FIG. 11, illustrated is a schematic diagram of a video playback device display 1100 when the video playback device is executing a system for creating and editing a video quote (e.g., systems 800 or 1000). The display can include a player 1102 that can display a video. While watching the video in the video playback device, a user can click a button to indicate that a clip should be taken. For example, the button can be a clip button and/or a pause button.

In response to receiving the indication that a clip should be taken, the player1102 can pause the video 1104. Upon pausing the video, playback controls of the player 1102 can be hidden. In the place of the playback controls, along the bottom of the player 1102, still images 1106 (e.g., snapshots) of the video are shown. For example, the still images 1106 can be taken at regular intervals over a time period. The time period can be thirty seconds (e.g., from twenty five seconds before the indication the clip should be taken is received until five seconds after the indication that the clip should be taken is received). The still images 1106 can be taken at regular and/or equal intervals during the time period.

A clip 1108 can be displayed. For example, the clip 1108 can include one or more of the still images 1106. The still images 1106 selected for the clip 1108 can be between two movable handles 1110. The still images 1106 between the handles 1110 can be highlighted, while the still images 1106 not selected for the clip 1108 can be dimmed and/or grayed out.

The handles 1110 can be adjusted (e.g., according to an input from the user) so that the clip can include a greater number of still images 1106. The handles 1110 can also be adjusted so that the clip can include a lesser number of still images 1106. When the handles 1110 are moved, the highlighted picture can be updated to include more still images 1106 from the film. The user can preview the clip 1108 when the user clicks on a play clip button (not shown).

When the user approves of the clip 1108, the user can press the done button 1112 to indicate that the clip should be saved and/or shared. When a user wishes to cancel creation of the clip 1108, the user can click the cancel button 1114 to indicate that the clip 1108 should be discarded. Upon receiving an indication that the clip should be discarded, the player 1102 can resume playback of the video and playback controls (not shown) again can be displayed.

Referring now to FIG. 12, illustrated a schematic diagram of a video playback device display 1200 when the video playback device is executing a system for creating, editing and sharing a video quote (e.g., system 900). The display can be similar to the display in example FIG. 11 (e.g., including the player 1102, paused video 1104, stills 1106, clip 1108, and handles 1110). FIG. 12 illustrates the functionality that becomes available after the user presses the done button (element 1112 of FIG. 11).

Upon indicating that the clip is finished (e.g., by pressing the done button, element 1112 of FIG. 11), the user is presented with the option of adding a title 1202 for the clip 1108. If a title is not entered and/or selected, the player 1102 can assign a default and/or random name for the clip 1108.

Upon selecting the save 1204 button, the user can be presented with, for example, a navigation window (not shown) that can allow the user to select a folder location where the clip can be saved. Additionally or alternatively, upon selecting the save and share 1206 button, the user can be presented with an option of selecting one or more social networks and/or credentials (e.g., user name and password) for the social network (not shown). When a user selects a social network, a menu 1208 can pop up with a list of friends 1210 on the social network that will be able to view the clip. The clip can also be shared via e-mail. The user can also be presented a textbox (not shown) where the user can enter one or more e-mail addresses of recipients of the clip.

FIGS. 13-16 illustrate methods that facilitate generating, editing and/or sharing a video quote. For simplicity of explanation, the methodologies are depicted and described as a series of acts. It is to be understood and appreciated that the various embodiments are not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methods described hereafter are capable of being stored on an article of manufacture (e.g., a computer readable storage medium) to facilitate transporting and transferring such methodologies to computers. The term article of manufacture, as used herein, is intended to encompass a computer program accessible from any computer-readable device, carrier, or media.

Referring now to FIG. 13, illustrated is a process flow diagram of a method 1300 for creating and editing a video quote. At element 1302, a video can be displayed on a screen of a video playback device. At element 1304, the video can be paused. For example, the video can be pushed upon receiving an input from a user. For example, the input can be due to selecting a button, such as a clip button or a pause button.

At element 1306, snapshots (e.g., still images or video captures) of the video can be displayed. The snapshots can be taken over a time interval. The time interval, for example, can be between twenty-five seconds before the move is paused and five seconds after the video is paused. The snapshots can be displayed, for example, in a horizontal line at the bottom of the screen.

At element 1306, a video quote can be created by editing the snapshots of the video over the interval based on input from a user of the video playback device. For example, the user can select a time length of the clip by selecting still images to be included in the video quote.

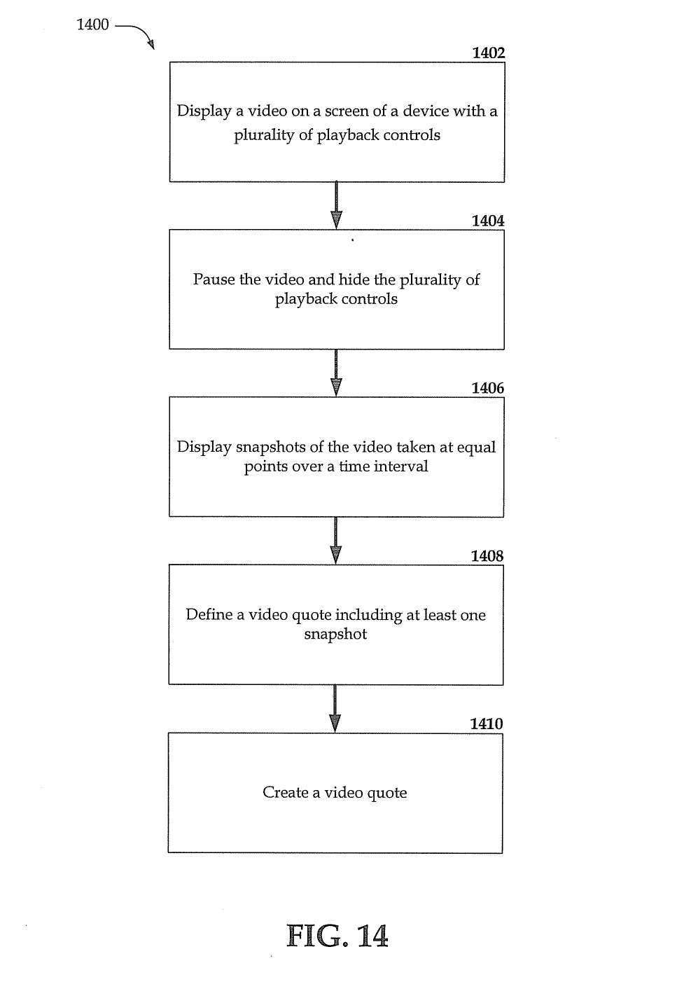

Referring now to FIG. 14, illustrated is a process flow diagram of a method 1400 for creating and editing a video quote. At element 1402, a video can be displayed on a screen of a video playback device with playback controls that can facilitate the display of the video. For example, the playback controls can be buttons, such as a play button, a pause button, a stop button, a fast forward button, and/or a rewind button. The playback controls can also, for example, include a clip button.

At element 1404, the video can be paused and the playback controls hidden. For example, the video can be pushed upon receiving an input from a user. For example, the input can be due to selecting a button, such as a clip button or a pause button.

At element 1406, snapshots of the video, taken at equal points over a time interval, can be displayed. The snapshots can be taken over a time interval. The time interval, for example, can be between twenty-five seconds before the move is paused and five seconds after the video is paused. The snapshots can be displayed, for example, in a horizontal line at the bottom of the screen.

At element 1408, a video quote can be defined. The video quote can include at least one snapshot. For example, the video quote can be defined by editing the snapshots of the video over the interval based on input from a user of the video playback device. For example, the user can select a time length of the clip by selecting still images to be included in the video quote. When the user has finished editing the video quote, the video quote can be saved, for example, in a memory associated with the video playback device. At element 1410, the video quote can be created.

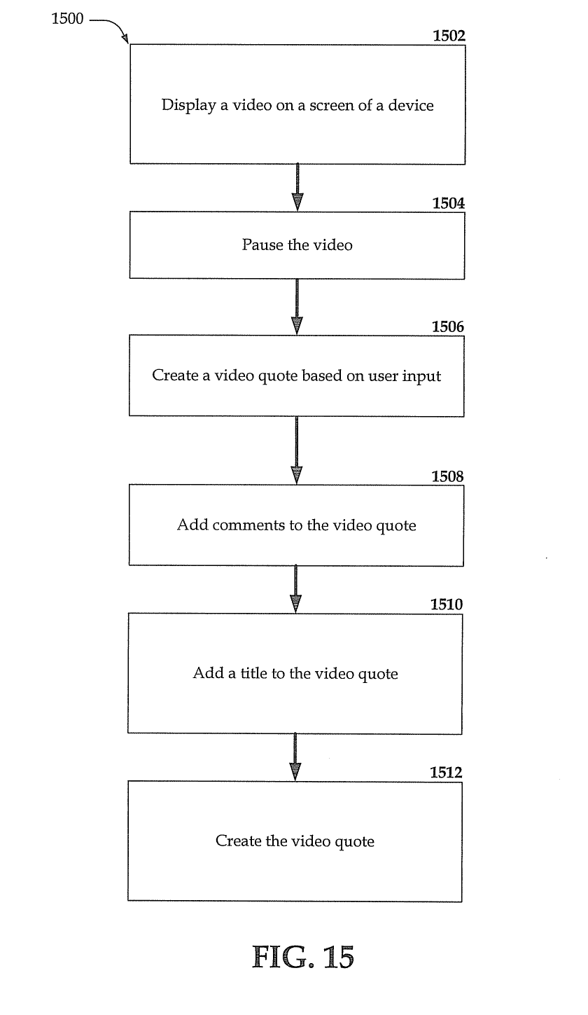

Referring now to FIG. 15, illustrated is a process flow diagram of a method 1500 for creating and editing a video quote. At element 1502, a video can be displayed on a screen of a video playback device. The display can include playback controls including, for example, buttons, such as a play button, a pause button, a stop button, a fast forward button, and/or a rewind button. The playback controls can also, for example, include a clip button.

At element 1504, the video can be paused. For example, the video can be paused upon receipt of an input indicating that the user has pressed a button, such as a pause button or a clip button. When the video is paused, the playback controls can be hidden.

At element 1506, a video quote can be created based on user input. The video quote can include at least one snapshot. For example, the video quote can be defined by editing the snapshots of the video over the interval based on input from a user of the video playback device. For example, the user can select a time length of the clip by selecting still images to be included in the video quote.

At element 1508, a user can add comments to the video quote. The comments can be about the specific clip included in the video quote, for example. Additionally or alternatively, the comments can be about the entire video. At element 1510, a title can be added to the video quote. The title can be based on an input from the user. If the user does not provide input, the title can be a default and/or random title determined by the player.

At element 1510, the video quote can be created. The video quote can include the clip, the comments and the title, for example. The video quote can be created upon receiving an indication that the user has finished editing the video quote (e.g., receiving an indication that the user has pressed a done button). When the user has finished editing the video quote, the video quote can be saved, for example, in a memory associated with the video playback device.

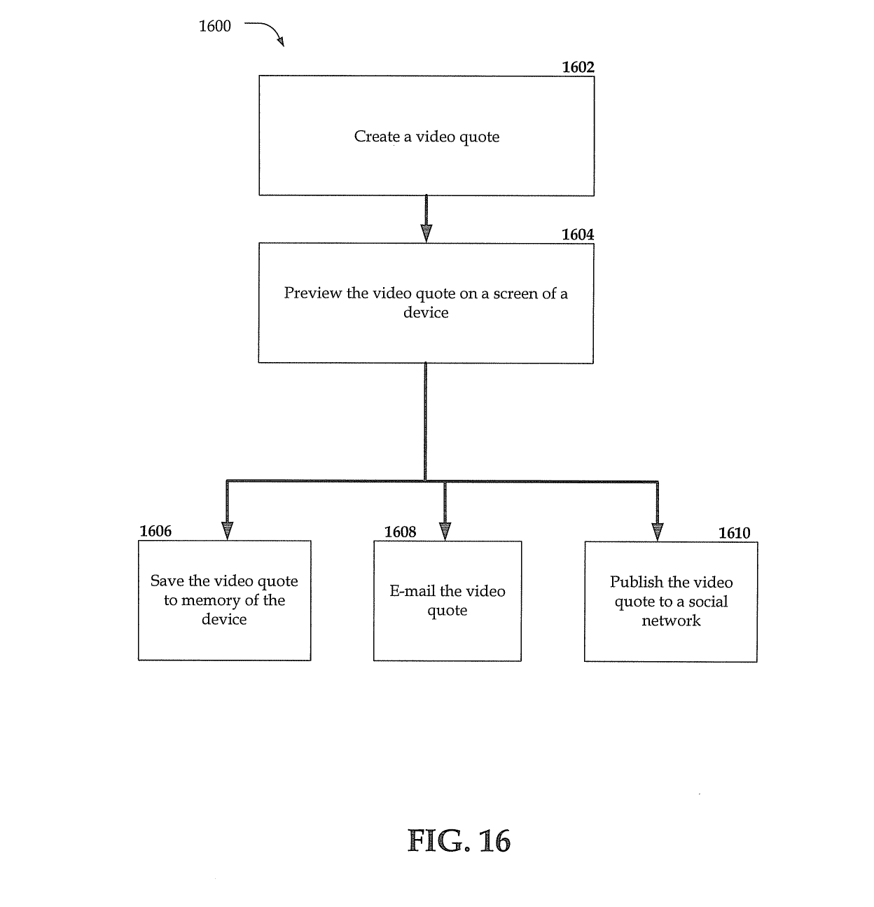

Referring now to FIG. 16, illustrated is a process flow diagram of a method for creating and sharing a video quote. At element 1602, a video quote can be created according to any one of methods 1300, 1400 or 1500. At element 1604, the video quote can be previewed on a screen of the video playback device. When the video quote is approved, a user has three options to publish and/or share the video quote. At element 1606, the video quote can be saved to memory of the video playback device. At element 1608, the video quote can be e-mailed (e.g., to recipients designated by the user of the video playback device). At element 1610, the video quote can be published to a social network.

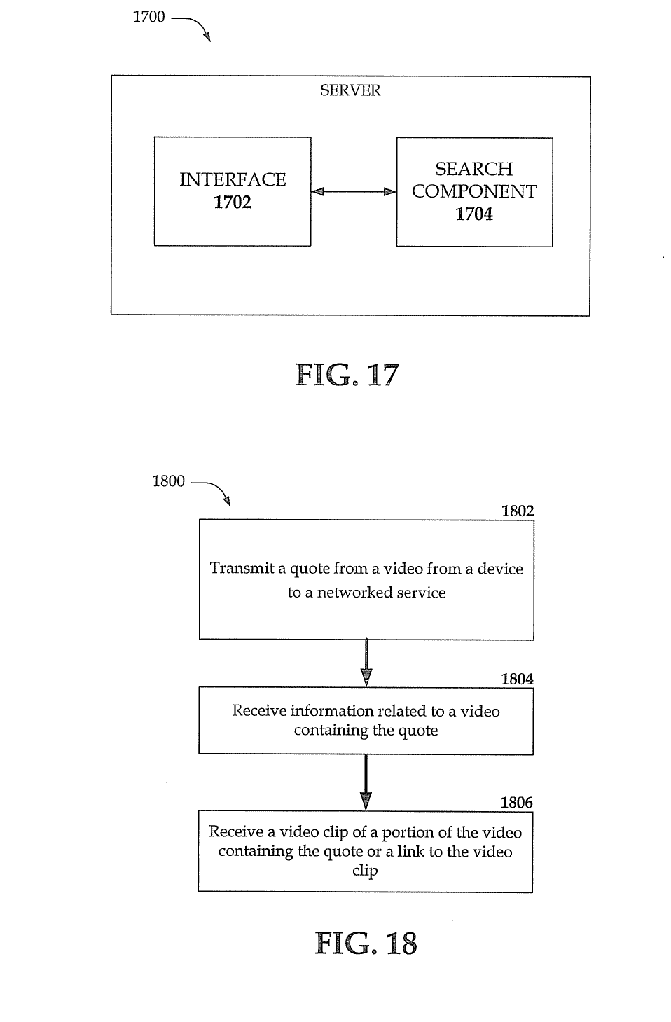

Referring now to FIG. 17, illustrated is an example block diagram of a server 1700 that can search a database for a video upon receiving a video quote. The server 1700 can be a cloud computing server. Server 1700 can, additionally or alternatively, be a computing device. Server 1700 can function as a search engine that, instead of providing links to various Web sites, provides video clips and/or links to video clips.

The server 1700 can include an interface 1702 that allows the server 1700 to communicate with a video playback device (not illustrated). The server 1700 can also include a search component 1704 that can search a database (not illustrated) for information about a video based on an input received from the video playback device.

The interface 1702 can receive an input from the video playback device. The input can include, for example, a quote from a video. The input can be a voice input where a user speaks the quote from the video. The input can, additionally or alternatively, include a text input or a graphic input. Upon receiving the input, the search component 1704 can search a database of videos for the video containing the quote. For example, the search can be based on the quote. According to a non-limiting illustrative example, a user of the video playback device can say, “Here's looking at you, kid,” and the search component can search the database for the video containing the quote, “Here's looking at you, kid.” Upon searching the database, the search component can find that the video including the quote is Casablanca. Also in the database, the search component 1704 can receive information regarding the video. For example, the search component 1704 can find information regarding a UID of the video containing the video quote. The search component 1704 can also find comments regarding the move and/or scene containing the quote. The search component 1704 can also find a video clip including the quote and a length of the video clip. Further, the search component 1704 can find information regarding a time point in the video where the quote occurs.

The interface 1702 can send information about the video to the video playback device. The interface 1702 can also send the video clip containing the quote to the video playback device. Additionally or alternatively, the interface can send a link to the video clip containing the quote to the video playback device. According to a non-limiting example, the search component 1704 can find Casablanca as the video containing the quote, “Here's looking at you, kid.” The search component 1704 can also find comments about the scene, for example, “This is the best scene ever!” Further, the search component can find a video clip (e.g., 15 seconds long) of Humphrey Bogart telling Ingrid Bergman, “Here's looking at you kid.” The interface 1702 can facilitate sending the video clip and/or a link to the video clip and/or the information to the video playback device.

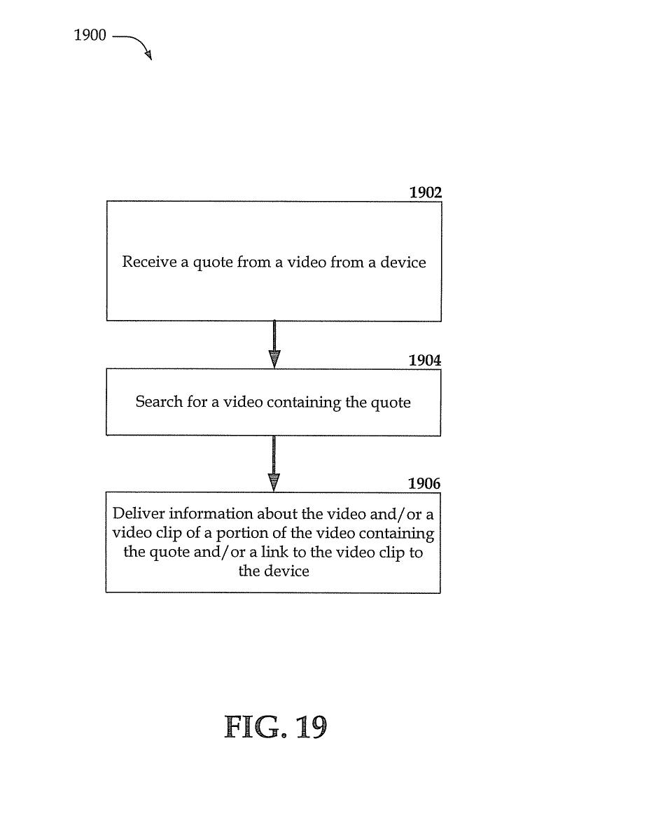

FIGS. 18 and 19 illustrate methods that facilitate searching a database for a video clip upon receiving a video quote. For simplicity of explanation, the methodologies are depicted and described as a series of acts. It is to be understood and appreciated that the various embodiments are not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methods described hereafter are capable of being stored on an article of manufacture (e.g., a computer readable storage medium) to facilitate transporting and transferring such methodologies to computers. The term article of manufacture, as used herein, is intended to encompass a computer program accessible from any computer-readable device, carrier, or media.

Referring now to FIG. 18, illustrated is a process flow diagram of a method for receiving a video clip based on a video quote. At element 1802, a quote from a video is transmitted from a video playback device to a networked service. The video playback device can receive the quote from the video from a user via, for example, a voice input, a text input, and/or a graphical input.

Upon receiving the quote, the network server (e.g., a cloud computing server) can search for a video that includes the quote. When the network server finds the video, it can send information about the move, a clip of the video scene containing the quote, and/or a link to a clip of the scene containing the quote.

At element 1804, the information related to the video containing the quote can be received by the video playback device. For example, the information can include a video UID, a time for the clip, and/or comments related to the video and/or the scene. At element 1806, the video clip of a portion of the video containing the quote and/or a link to the video clip can be received at the video playback device.

Referring now to FIG. 19, illustrated is a process flow diagram of a method that the network server can employ for finding a video clip based on a video quote. At element 1902, a quote from a video can be received from a video playback device. For example, the quote can be received by a networked server, such as a cloud computing server. The quote can be received based on an input from a user of a video playback device. The input can be, for example, in a text format, a voice format, and/or an image format.

At element 1904, the networked server can search for a video containing the quote. For example, the networked server can search and associated database of videos and/or video quotes based on the input of the quote. The networked server can determine the video that includes the quote. The networked server can retrieve information about the video. For example, a UID associated with the move. Additionally, the information can include comments associated with the video. Based on the quote, the networked server can find the scene of the video that includes the quote. The information about the video can also include, for example, a length of the clip and/or a time of the video where the quote occurs.

At element 1906, the network server can deliver information about the video including the quote to the video playback device. The network server can also deliver a video clip of a portion of the video that contains the quote to the video playback device. Additionally or alternatively, the network server can deliver a link to the video clip to the video playback device.

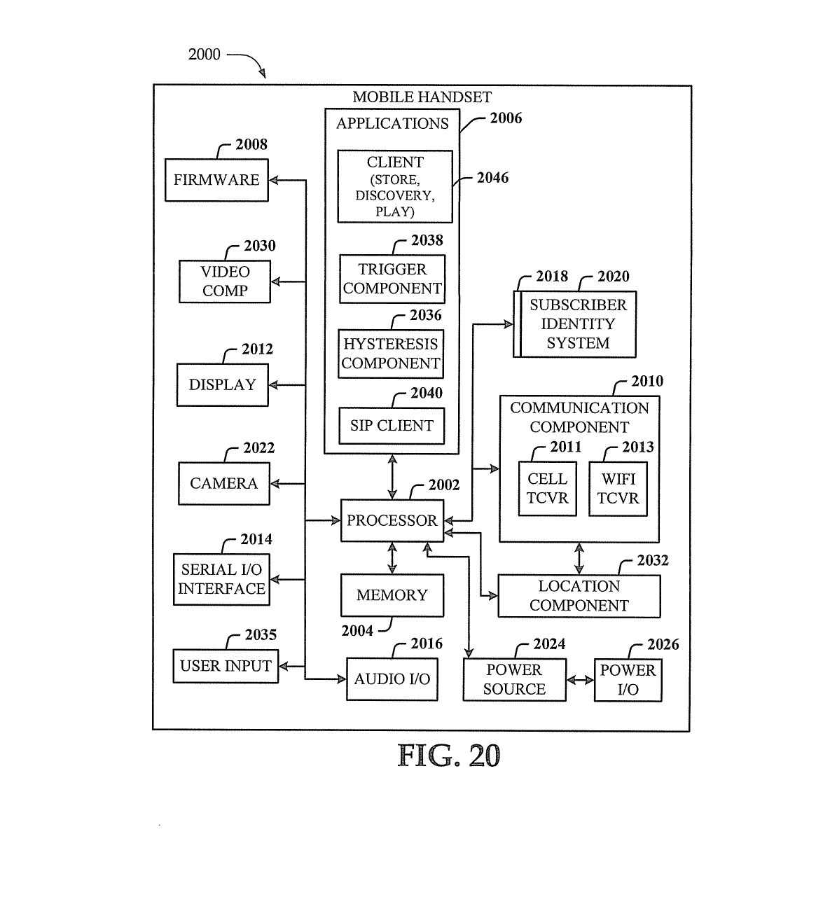

Referring now to FIG. 20, illustrated is a schematic block diagram of an exemplary mobile device 2000 capable of generating, editing and sharing video clips in accordance with some embodiments described herein. Although a mobile handset 2000 is illustrated herein, it will be understood that other devices can be a mobile device, and that the mobile handset 2000 is merely illustrated to provide context for the embodiments of the innovation described herein. The following discussion is intended to provide a brief, general description of an example of a suitable environment 2000 in which the various embodiments can be implemented. While the description includes a general context of computer-executable instructions embodied on a computer readable storage medium, those skilled in the art will recognize that the innovation also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of computer-readable media. Computer readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RE, infrared and other wireless media. Combinations of the any of the above should also be included within the scope of computer-readable media.

The handset 2000 includes a processor 2002 for controlling and processing all onboard operations and functions. A memory 2004 interfaces to the processor 2002 for storage of data and one or more applications 2006 (e.g., a video player software, user feedback component software, etc.). Other applications can include voice recognition of predetermined voice commands that facilitate initiation of the user feedback signals. The applications 2006 can be stored in the memory 2004 and/or in a firmware 2008, and executed by the processor 2002 from either or both the memory 2004 or/and the firmware 2008. The firmware 2008 can also store startup code for execution in initializing the handset 2000. A communications component 2010 interfaces to the processor 2002 to facilitate wired/wireless communication with external systems, e.g., cellular networks, VoIP networks, and so on. Here, the communications component 2010 can also include a suitable cellular transceiver 2011 (e.g., a GSM transceiver) and/or an unlicensed transceiver 2013 (e.g., WiFi, WiMax) for corresponding signal communications. The handset 2000 can be a device such as a cellular telephone, a PDA with mobile communications capabilities, and messaging-centric devices. The communications component 2010 also facilitates communications reception from terrestrial radio networks (e.g., broadcast), digital satellite radio networks, and Internet-based radio services networks.

The handset 2000 includes a display 2012 for displaying text, images, video, telephony functions (e.g., a Caller ID function), setup functions, and for user input. For example, the display 2012 can also be referred to as a “screen” that can accommodate the presentation of multimedia content (e.g., music metadata, messages, wallpaper, graphics, etc.). The display 2012 can also display videos and can facilitate the generation, editing and sharing of video quotes. A serial I/O interface 2014 is provided in communication with the processor 2002 to facilitate wired and/or wireless serial communications (e.g., USB, and/or IEEE 1394) through a hardwire connection, and other serial input devices (e.g., a keyboard, keypad, and mouse). This supports updating and troubleshooting the handset 2000, for example. Audio capabilities are provided with an audio I/O component 2016, which can include a speaker for the output of audio signals related to, for example, indication that the user pressed the proper key or key combination to initiate the user feedback signal. The audio I/O component 2016 also facilitates the input of audio signals through a microphone to record data and/or telephony voice data, and for inputting voice signals for telephone conversations.

The handset 2000 can include a slot interface 2018 for accommodating a SIC (Subscriber Identity Component) in the form factor of a card Subscriber Identity Module (SIM) or universal SIM 2020, and interfacing the SIM card 2020 with the processor 2002. However, it is to be appreciated that the SIM card 2020 can be manufactured into the handset 2000, and updated by downloading data and software.

The handset 2000 can process IP data traffic through the communication component 2010 to accommodate IP traffic from an IP network such as, for example, the Internet, a corporate intranet, a home network, a person area network, etc., through an ISP or broadband cable provider. Thus, VoIP traffic can be utilized by the handset 1200 and IP-based multimedia content can be received in either an encoded or decoded format.

A video processing component 2022 (e.g., a camera) can be provided for decoding encoded multimedia content. The video processing component 2022 can aid in facilitating the generation, editing and sharing of video quotes. The handset 2000 also includes a power source 2024 in the form of batteries and/or an AC power subsystem, which power source 2024 can interface to an external power system or charging equipment (not shown) by a power I/O component 2026.

The handset 2000 can also include a video component 2030 for processing video content received and, for recording and transmitting video content. For example, the video component 2030 can facilitate the generation, editing and sharing of video quotes. A location tracking component 2032 facilitates geographically locating the handset 2000. As described hereinabove, this can occur when the user initiates the feedback signal automatically or manually. A user input component 2034 facilitates the user initiating the quality feedback signal. The user input component 2034 can also facilitate the generation, editing and sharing of video quotes. The user input component 2034 can include such conventional input device technologies such as a keypad, keyboard, mouse, stylus pen, and/or touch screen, for example.

Referring again to the applications 2006, a hysteresis component 2036 facilitates the analysis and processing of hysteresis data, which is utilized to determine when to associate with the access point. A software trigger component 2038 can be provided that facilitates triggering of the hysteresis component 2038 when the WiFi transceiver 2013 detects the beacon of the access point. A SIP client 2040 enables the handset 2000 to support SIP protocols and register the subscriber with the SIP registrar server. The applications 2006 can also include a client 2042 that provides at least the capability of discovery, play and store of multimedia content, for example, music.

The handset 2000, as indicated above related to the communications component 2010, includes an indoor network radio transceiver 2013 (e.g., WiFi transceiver). This function supports the indoor radio link, such as IEEE 802.11, for the dual-mode GSM handset 2000. The handset 2000 can accommodate at least satellite radio services through a handset that can combine wireless voice and digital radio chipsets into a single handheld device.

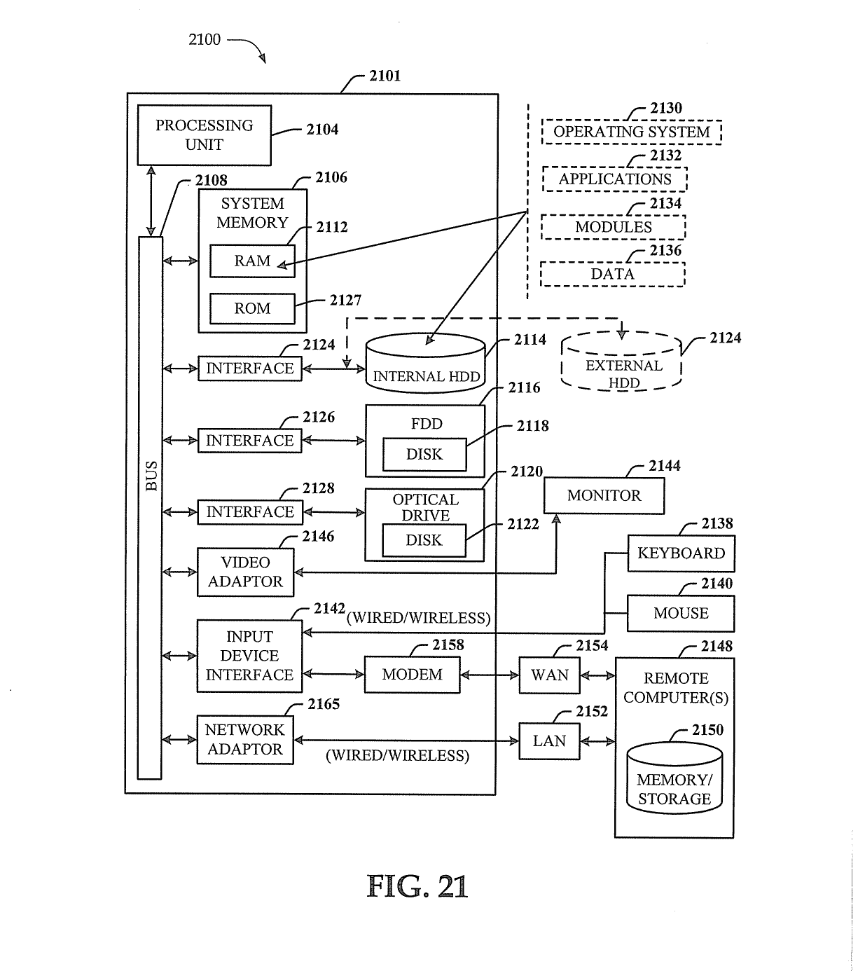

Referring now to FIG. 21, there is illustrated a block diagram of a computer operable to execute a system architecture that facilitates generating, editing, and sharing of video quotes. The computer can provide networking and communication capabilities between a wired or wireless communication network and a server and/or communication device. In order to provide additional context for various aspects thereof, FIG. 21 and the following discussion are intended to provide a brief, general description of a suitable computing environment 2100 in which the various aspects of the innovation can be implemented to facilitate the generation, editing, and sharing of video quotes. While the description above is in the general context of computer-executable instructions that can run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media can embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 21, the exemplary environment 2100 for implementing various aspects described herein includes a computer 2102, the computer 2102 including a processing unit 2104, a system memory 2106 and a system bus 2108. The system bus 2108 couples system components including, but not limited to, the system memory 2106 to the processing unit 2104. The processing unit 2104 can be any of various commercially available processors. Dual microprocessors and other multi processor architectures can also be employed as the processing unit 2104.

The system bus 2108 can be any of several types of bus structure that can further interconnect to a memory bus (with or without a memory controller), a peripheral bus, and a local bus using any of a variety of commercially available bus architectures. The system memory 2106 includes read-only memory (ROM) 2110 and random access memory (RAM) 2112. A basic input/output system (BIOS) is stored in a non-volatile memory 2110 such as ROM, EPROM, EEPROM, which BIOS contains the basic routines that help to transfer information between elements within the computer 2102, such as during start-up. The RAM 2112 can also include a high-speed RAM such as static RAM for caching data.

The computer 2102 further includes an internal hard disk drive (HDD) 2114 (e.g., EIDE, SATA), which internal hard disk drive 2114 can also be configured for external use in a suitable chassis (not shown), a magnetic floppy disk drive (FDD) 2116, (e.g., to read from or write to a removable diskette 2118) and an optical disk drive 2120, (e.g., reading a CD-ROM disk 2122 or, to read from or write to other high capacity optical media such as the DVD). The hard disk drive 2114, magnetic disk drive 2116 and optical disk drive 2111 can be connected to the system bus 2108 by a hard disk drive interface 2124, a magnetic disk drive interface 2126 and an optical drive interface 2128, respectively. The interface 2124 for external drive implementations includes at least one or both of Universal Serial Bus (USB) and IEEE 2194 interface technologies. Other external drive connection technologies are within contemplation of the subject innovation.

The drives and their associated computer-readable media provide nonvolatile storage of data, data structures, computer-executable instructions, and so forth. For the computer 2102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 2112, including an operating system 2130, one or more application programs 2132, other program modules 2134 and program data 2136. All or portions of the operating system, applications, modules, and/or data can also be cached in the RAM 2112. It is to be appreciated that the innovation can be implemented with various commercially available operating systems or combinations of operating systems.

A user can enter commands and information into the computer 2102 through one or more wired/wireless input devices, e.g., a keyboard 2138 and a pointing device, such as a mouse 2140. Other input devices (not shown) may include a microphone, an IR remote control, a joystick, a game pad, a stylus pen, touch screen, or the like. These and other input devices are often connected to the processing unit 2104 through an input device interface 2142 that is coupled to the system bus 2108, but can be connected by other interfaces, such as a parallel port, an IEEE 2394 serial port, a game port, a USB port, an IR interface, etc.

A monitor 2144 or other type of display device is also connected to the system bus 2108 through an interface, such as a video adapter 2146. In addition to the monitor 2144, a computer typically includes other peripheral output devices (not shown), such as speakers, printers, etc.

The computer 2102 can operate in a networked environment using logical connections by wired and/or wireless communications to one or more remote computers, such as a remote computer(s) 2148. The remote computer(s) 2148 can be a workstation, a server computer, a router, a personal computer, portable computer, microprocessor-based entertainment appliance, a peer device or other common network node, and typically includes many or all of the elements described relative to the computer 2102, although, for purposes of brevity, only a memory/storage device 2150 is illustrated. The logical connections depicted include wired/wireless connectivity to a local area network (LAN) 2152 and/or larger networks, e.g., a wide area network (WAN) 2154. Such LAN and WAN networking environments are commonplace in offices and companies, and facilitate enterprise-wide computer networks, such as intranets, all of which may connect to a global communications network, e.g., the Internet.

When used in a LAN networking environment, the computer 2102 is connected to the local network 2152 through a wired and/or wireless communication network interface or adapter 2156. The adapter 2156 may facilitate wired or wireless communication to the LAN 2152, which may also include a wireless access point disposed thereon for communicating with the wireless adapter 2156.

When used in a WAN networking environment, the computer 2102 can include a modem 2158, or is connected to a communications server on the WAN 2154, or has other means for establishing communications over the WAN 2154, such as by way of the Internet. The modem 2158, which can be internal or external and a wired or wireless device, is connected to the system bus 2108 through the serial port interface 2142. In a networked environment, program modules depicted relative to the computer 2102, or portions thereof, can be stored in the remote memory/storage device 2150. It will be appreciated that the network connections shown are exemplary and other means of establishing a communications link between the computers can be used.

The computer 2102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least WiFi and Bluetooth™ wireless technologies. Thus, the communication can be a predefined structure as with a conventional network or simply an ad hoc communication between at least two devices.

WiFi, or Wireless Fidelity, allows connection to the Internet from a couch at home, a bed in a hotel room, or a conference room at work, without wires. WiFi is a wireless technology similar to that used in a cell phone that enables such devices, e.g., computers, to send and receive data indoors and out; anywhere within the range of a base station. WiFi networks use radio technologies called IEEE 802.11(a, b, g, etc.) to provide secure, reliable, fast wireless connectivity. A WiFi network can be used to connect computers to each other, to the Internet, and to wired networks (which use IEEE 802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, from a video playback device, a request for content related to a video based on a time range;
validating the request for the content related to the video;
creating a video quote comprising the content related to the video based on the time range; and
sending a link to the video quote to the video playback device.

2. The method of claim 1, wherein the receiving further comprises receiving the request for the content related to the video based on a video unique identification number (UID).

3. The method of claim 1, wherein the receiving further comprises receiving a comment regarding the content related to the video.

4. The method of claim 1, wherein the validating further comprises authenticating a user of the video playback device to edit the content related to the video.

5. The method of claim 1, wherein the validating further comprises checking a permission of a user of the video playback device to edit the video.

6. The method of claim 1, wherein the validating further comprises generating a session token for the user indicating a permission to work with the content related to the video.

7. The method of claim 1, wherein the creating the video quote further comprises creating the video quote in a flash video format for the time range.

8. The method of claim 1, wherein the sending the link to the video quote further comprises sending the link to a preview of the video quote.

9. The method of claim 1, further comprising:
automatically logging into a social network with a saved credential of a user of the video playback device; and
uploading the video quote to the social network.

10. The method of claim 9, wherein the uploading the video quote to the social network further comprises uploading a comment related to the content.

11. The method of claim 1, further comprising:
identifying a valid network session on the video playback device;
automatically downloading the video quote to the video playback device;
logging into a social network with a user name and password from the video playback device; and
uploading the video quote to the social network.

12. The method of claim 11, wherein the uploading the video quote to the social network further comprises uploading a comment related to the content.

13. The method of claim 1, further comprising:
identifying a browser client on the video playback device;
downloading the video quote to the video playback device upon receiving a first command from a user;
publishing the video quote from the video playback device upon receiving a second command from the user.

14. A system, comprising:
a receiving component configured to receive a request for content related to a video from a video playback device, wherein the request for the content related to the video comprises a time range applicable to the content related to the video and a comment related to the content;
a security component configured to validate a permission related to the request for the content;
a context component configured to create a video quote comprising the content for the time range and the comment related to the content; and
a response component configured to send a reference to the video quote to the video playback device.

15. The system of claim 14, wherein the request for the content related to the video further comprises a video unique identification number (UID).

16. The system of claim 14, wherein the context component is further configured to create the video quote formatted in a flash video format.

17. The system of claim 14, wherein the security component is further configured to generate a session token for a user of the video playback device based on the permission.

18. The system of claim 14, wherein the permission enables a user of the video playback device to share the video quote.

19. The system of claim 14, wherein the reference enables a user of the video playback device to preview the video quote.

20. The system of claim 14, wherein the reference enables a user of the video playback device to download the video quote.

21. The system of claim 14, further comprising a publishing component configured to:
automatically log into a social network with a saved username and a saved password received from a user of the video playback device; and
automatically upload the video quote to the social network.

22. The system of claim 14, further comprising a download component configured to download the video quote to the video playback device.

23. The system of claim 22, further comprising a publishing component configured to:
receive an input comprising user credentials for a social network;
log into the social network employing the user credentials; and
automatically upload the video quote to the social network.

24. The system of claim 14, further comprising a detection component configured to identify a browser client on the video playback device.

25. The system of claim 24, further comprising a publishing component configured to:
facilitate a download of the video quote upon receiving a first user command; and
facilitate a publication of the video quote from the video playback device upon receiving a second user command.

26. A computer readable storage medium having stored thereon computer executable instructions that, in response to execution, cause a computing system to perform operations comprising:
authorizing a user of a video playback device to edit a video;
generating a clip of the video based on a unique identification number (UID) associated with the video and a time range for the clip;
generating a video quote by associating the clip with a comment received from the user of the video playback device;
sending a link to the video quote to the video playback device; and
publishing the video quote on a social network.

27. The computer readable storage medium of claim 26, wherein the publishing the video quote to the social network further comprises:
accessing a stored username and a stored password for the social network;
logging into the social network utilizing the stored username and the stored password; and
uploading the video quote to the social network.

28. The computer readable storage medium of claim 26, wherein the publishing the video quote to the social network further comprises:
receiving a username and password for the social network;
logging into the social network utilizing the username and password; and
uploading the video quote to the social network.

29. The computer readable storage medium of claim 26, wherein the authorizing the user of the video playback device to edit the video further comprises authorizing the user of the video playback device to share the clip.

30. The computer readable storage medium of claim 26, wherein the authorizing the user of the video playback device to edit the video further comprises generating a session token indicating at least one permission of the user associated with editing the video.

31. The computer readable storage medium of claim 26, wherein the creating a clip of the video further comprises formatting the clip of the video in a flash video format.

32. A method, comprising:
displaying a video on a screen of a video playback device;
pausing the video;
displaying a plurality of snapshots of the video over a time interval; and
creating a video quote by editing the time interval to include at least one of the plurality of snapshots based on input from a user of the video playback device.

33. The method of claim 32, wherein the displaying the video on the screen of the video playback device further comprises displaying a plurality of playback controls.

34. The method of claim 33, wherein the pausing the video further comprises hiding the plurality of playback controls.

35. The method of claim 32, wherein the displaying the plurality of snapshots of the video over the time interval further comprises displaying the plurality of snapshots of the video over the time interval between at least twenty five seconds before the video is paused and at least five seconds after the video is paused.

36. The method of claim 32, wherein the displaying the snapshot of the interval of the video further comprises displaying a plurality of snapshots of the video taken at equal time intervals.

37. The method of claim 36, wherein the displaying the snapshot of the interval of the video further comprises displaying the plurality of snapshots of the video at a bottom of the screen of the video playback device.

38. The method of claim 32, wherein the creating the video quote further comprises adding a comment to the video quote.

39. The method of claim 32 wherein the creating the video quote further comprises receiving an indication that editing of the at least one of the plurality of snapshots of the video is complete.

40. The method of claim 32, further comprising adding a title to the video quote.

41. The method of claim 40, wherein the adding the title comprises adding a title to the video quote according to an input from the user.

42. The method of claim 40, wherein the adding the title comprises adding a default title to the video quote.

43. The method of claim 32, further comprising saving the video quote to a memory associated with the video playback device.

44. The method of claim 32, further comprising sharing the video quote on a social network.

45. The method of claim 32, further comprising sending the video quote as an e-mail.

46. A system, comprising:
a player component configured to display a video on a video playback device;
a clip component configured to pause the video and create a clip of the video;
an editing component configured to adjust a length of the clip of the video; and
a comment component configured to add a comment to the clip of the video.

47. The system of claim 46, further comprising a share component configured to facilitate publishing the clip of the video and the comment to a social networking site.

48. The system of claim 46, further comprising a share component configured to facilitate e-mail of the clip of the video and the comment.

49. The system of claim 46, wherein the clip component is configured to facilitate creation the clip of the video according to a time interval.

50. The system of claim 49, wherein the time interval is between approximately twenty-five seconds before the video is paused and approximately five seconds after the video is paused.

51. The system of claim 49, wherein the clip component further comprises a display component configured to display snapshots of the clip, wherein the snapshots are equally spaced in the time interval.

52. The system of claim 46, wherein the editing component is further configured to adjust the length of the clip of the video according to input from the user.

53. The system of claim 52, wherein the input from the user is based on a movement of at least one handle on a side of the clip of the video.

54. A video playback device, comprising:
means for playing a film;
means for pausing the film;
means for creating a clip of the film when the film is paused; and
means for publishing the clip of the film to a remote device via a network.

55. The video playback device of claim 54, wherein the means for publishing the clip of the film comprises means for uploading the clip of the film to a social networking site.

56. The video playback device of claim 54, wherein the means for publishing the clip of the film comprises means for sending an e-mail including the clip of the film.

57. The video playback device of claim 54, wherein the means for creating the clip of the film further comprises means for adding a comment to the clip of the film.

58. The video playback device of claim 54, wherein the means for creating the clip of the film further comprises means for adding a title to the clip of the film.

59. The video playback device of claim 54, wherein the means for creating the clip of the film includes means for creating the clip of the film at two time endpoints according to an input from a user.

60. The video playback device of claim 54, wherein the means for creating the clip of the film further comprises:
means for editing the clip of the film; and
means for saving the clip of the film.

61. A method, comprising:
transmitting a quote from a video from a video playback device to a networked service;
receiving information related to one or more videos containing the quote from the networked service; and
receiving by the video playback device a video clip of a portion of the video containing the quote or a link to the video clip from the networked service.

62. The method of claim 61, further comprising if the one or more videos include at least two videos, transmitting a selection of one of the at least two videos containing the quote from the video playback device to the networked service.

63. The method of claim 61, further comprising sharing the video clip or the link to the video clip with at least one contact stored on the video playback device.

64. The method of claim 61, wherein the receiving the information includes receiving a title of the video.

65. The method of claim 61, wherein the receiving the information includes receiving a unique identifier associated with the video.

66. The method of claim 61, wherein the receiving the information includes receiving an image associated with the video.

67. A computing device, comprising:
an interface configured to receive information related to a video quote from a video playback device;
a search component configured to search a data store of videos and associated video quotes for one or more videos that contain the video quote,
wherein the interface is further configured to transmit video information related to the one or more videos to the video playback device.

68. A method, comprising:
receiving a quote from a video from a video playback device;
searching for a video containing the quote based on the quote;
delivering information about the video to the video playback device; and
delivering a video clip of a portion of the video containing the quote or a link to the video clip to the video playback device.

69. The method of claim 68, wherein the receiving the quote includes receiving voice input from a user and converting the voice input to text.

70. The method of claim 68, wherein the delivering the information includes delivering a title of the video.

71. The method of claim 68, wherein the delivering the information includes delivering a unique identifier associated with the video.

72. The method of claim 68, wherein the delivering the information includes delivering an image associated with the video.

73. A server, comprising:
an interface configured to receive a quote from a video from a video playback device; and
a search component configured to search a database for a video containing the quote based on the quote,
wherein the interface is further configured to deliver information about the video, a video clip of a portion of the video containing the quote or a link to the video clip to the video playback device.
